(19) United States
(12) Patent Application Publication
(10) Pub. No.: US 2015/0043745 A1
(43) Pub. Date: Feb. 12, 2015

(54) METHODS, SYSTEMS AND APPARATUS FOR PROVIDING AUDIO INFORMATION AND CORRESPONDING TEXTUAL INFORMATION FOR PRESENTATION AT AN AUTOMOTIVE HEAD UNIT

(71) Applicant: GM GLOBAL TECHNOLOGY OPERATIONS LLC, Detroit, MI (US)

(72) Inventors: KAREN JUZSWIK, YPSILANTI, MI (US); ROBERT A. HRABAK, WEST BLOOMFIELD, MI (US)

(73) Assignee: GM GLOBAL TECHNOLOGY OPERATIONS LLC, Detroit, MI (US)

(21) Appl. No.: 13/965,030

(22) Filed: Aug. 12, 2013

(51) Int. Cl. H04B 1/00

(52) U.S. Cl. CPC H04B 1/00
USPC 381/86

(57) ABSTRACT

Computer-implemented methods, systems and apparatus are disclosed for providing information and corresponding textual information to an automotive head unit (AHU) of a vehicle. A first server generates audio information and communicates it to a wireless communication interface of a network access device (NAD) that is located at a vehicle. A second server generates corresponding textual information that is associated with the audio information, and communicates the corresponding textual information to the wireless communication interface of the NAD. The NAD can then communicate the audio information and the corresponding textual information to the automotive head unit (AHU) of the vehicle. The AHU can then process the audio information and the corresponding textual information. The processing performed at the AHU includes synchronizing the audio information with the corresponding textual information so that the corresponding textual information can then be presented at a human-machine interface (HMI) of the AHU in synchronization with the audio information while it is played over an audio system of the vehicle.

### TECHNICAL FIELD

The technical field generally relates to vehicle communications, and more particularly relates to methods, systems and apparatus for providing audio information and corresponding textual information to an automotive head unit (AHU) of a vehicle.

### BACKGROUND

Many vehicles today include on-board computers that perform a variety of functions. For example, on-board computers control operation of the engine, control systems within the vehicle, provide security functions, perform diagnostic checks, provide information and entertainment services to the vehicle, perform navigation tasks, and facilitate communications with other vehicles and remote driver-assistance centers. Telematics service systems, for example, provide services including in-vehicle safety and security, hands-free calling, turn-by-turn navigation, and remote-diagnostics.

On-board computers also facilitate delivery to the driver of information and entertainment, which are sometimes referred to collectively as infotainment. Infotainment can include, for example, data related to news, weather, sports, music, and notifications about vehicle location and nearby traffic. Infotainment can be delivered in any of a wide variety of forms, including text, video, audio, and combinations of these.

Mobile devices, such as smartphones, have given consumers access to a growing number of applications anytime anywhere. However, these applications are of limited use while driving, and even the most advanced car infotainment systems cannot match functionality offered by most smartphone applications.

Accordingly, it is desirable to provide methods and systems that leverage the technologies that are already present within the vehicle's infotainment system to provide content that can be presented via display(s) and audio system(s) within the vehicle. Furthermore, other desirable features and characteristics of the present invention will become apparent from the subsequent detailed description and the appended claims, taken in conjunction with the accompanying drawings and the foregoing technical field and background.

### SUMMARY

Computer-implemented methods, systems and apparatus are provided for providing audio information and its corresponding textual information to an automotive head unit (AHU) of a vehicle so that the corresponding textual information can be presented at a human-machine interface of the AHU when the audio information is being played in the vehicle.

In one embodiment, a system is provided. The system includes a network access device (NAD) and an automotive head unit (AHU) of a vehicle that is communicatively coupled to the NAD. The AHU includes a processor and a human-machine interface (HMI). The NAD receives audio information generated by a first server and corresponding textual information generated by a second server. The corresponding textual information corresponds to the audio information. The processor synchronizes the audio information with the corresponding textual information, and the HMI presents the corresponding textual information in synchronization with the audio information when the audio information is played on an audio system of the vehicle.

In another embodiment, a computer-implemented method is provided for providing information and corresponding textual information to an automotive head unit (AHU) of a vehicle. For example, In accordance with the computer-implemented method, a first server generates audio information and communicates it to a wireless communication interface of a network access device (NAD) that is located at a vehicle. A second server generates corresponding textual information that is associated with the audio information, and communicates the corresponding textual information to the wireless communication interface of the NAD. The NAD can then communicate the audio information and the corresponding textual information to the automotive head unit (AHU) of the vehicle. The AHU can then process the audio information and the corresponding textual information. The processing performed at the AHU includes synchronizing the audio information with the corresponding textual information so that the corresponding textual information can then be presented at a human-machine interface (HMI) of the AHU in synchronization with the audio information.

In another embodiment, a vehicle is provided. The vehicle includes a wireless communication interface, and an automotive head unit (AHU), communicatively coupled to the wireless communication interface. The AHU includes a processor and a human machine interface (HMI). The wireless communication interface can receive audio information and corresponding textual information via a wireless communication link. The processor can synchronize the audio information with the corresponding textual information so that the corresponding textual information can be presented in synchronization with the audio information at the HMI.

### DESCRIPTION OF THE DRAWINGS

The exemplary embodiments will hereinafter be described in conjunction with the following drawing figures, wherein like numerals denote like elements, and wherein:

FIG. 1 is a communication system 100 in accordance with some of the disclosed embodiments.

FIG. 2 is a diagram that illustrates a portion of a communication system 200 in accordance with one example of the disclosed embodiments.

FIG. 3 is a diagram that illustrates a portion of a communication system 300 in accordance with another example of the disclosed embodiments.

FIGS. 4 and 5 provide examples of an interior portion of a vehicle that includes displays that are described with reference to FIGS. 2 and 3.

### DETAILED DESCRIPTION

Various embodiments of the present disclosure are disclosed herein. The disclosed embodiments are merely examples that may be embodied in various and alternative forms, and combinations thereof. The following detailed description is merely exemplary in nature and is not intended to limit the application and uses. The word “exemplary” is used exclusively herein to mean “serving as an example, instance, or illustration.” Any embodiment described herein as “exemplary” is not necessarily to be construed as preferred or advantageous over other embodiments. As used herein, for example, “exemplary” and similar terms, refer expansively to embodiments that serve as an illustration, specimen, model or pattern. Furthermore, there is no intention to be bound by any expressed or implied theory presented in the preceding technical field, background, brief summary or the following detailed description.

### Overview

Before describing some of the disclosed embodiments, it should be observed that the disclosed embodiments generally relate to systems that include an onboard computer system of a vehicle, such as an automobile, that is in communication with remote servers. The remote servers provide or deliver audio information (e.g., music or a song) and corresponding textual information (e.g., lyrics of a song) to an automotive head unit (AHU) of the vehicle. The corresponding textual information is associated with or corresponds to audio, and is synchronized with the audio information during play back over an audio system and presented on a human-machine interface of the AHU. The terms information, data, and content are used interchangeably herein. Further, any type of information, data, or content referred to herein not only encompasses that information, data, or content, but can also include metadata associated with that information, data, or content. Related methods, computer-readable media, computer-executable instructions are also disclosed.

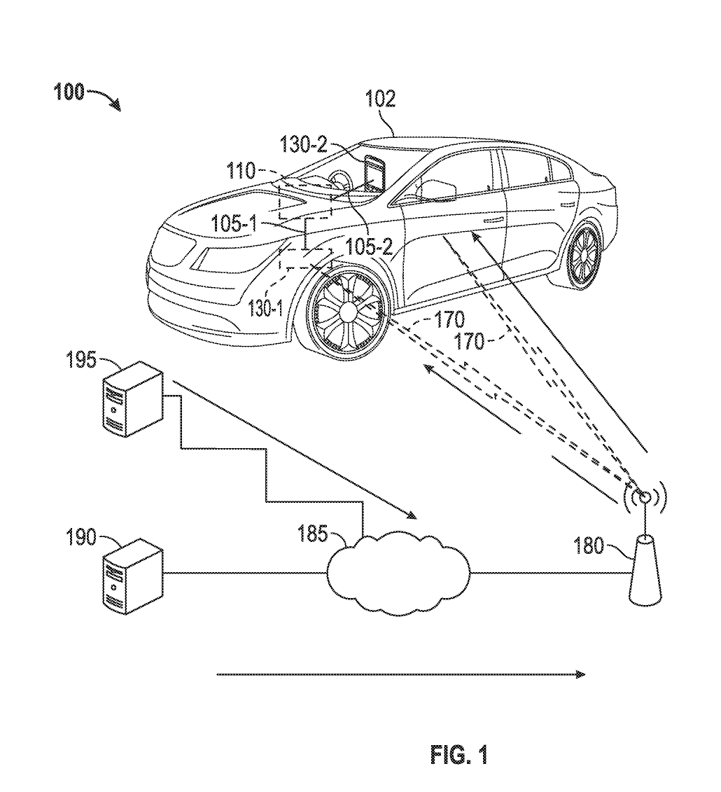

FIG. 1 is a communication system 100 in accordance with some of the disclosed embodiments. The communication system 100 includes a vehicle 102, communication infrastructure 180, a network 185 such as the Internet, a first application server 190, and a second application server 195.

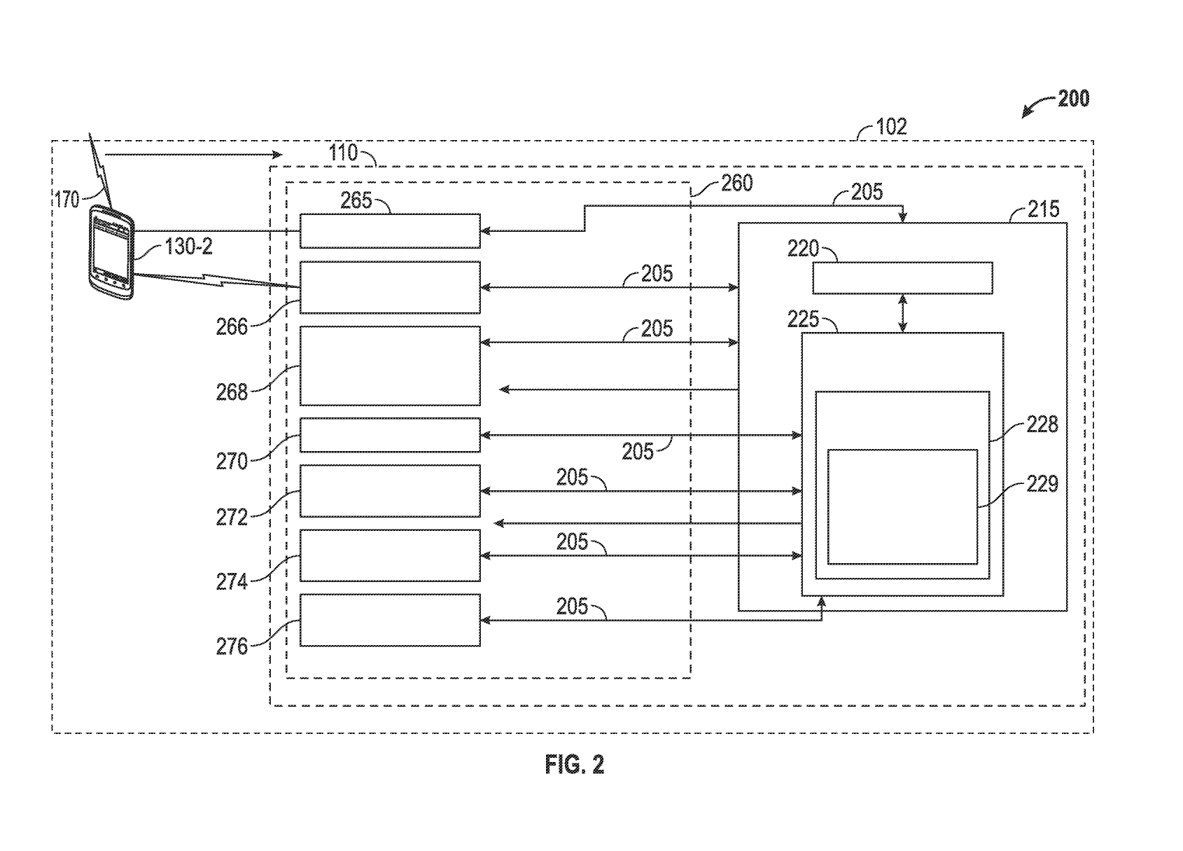

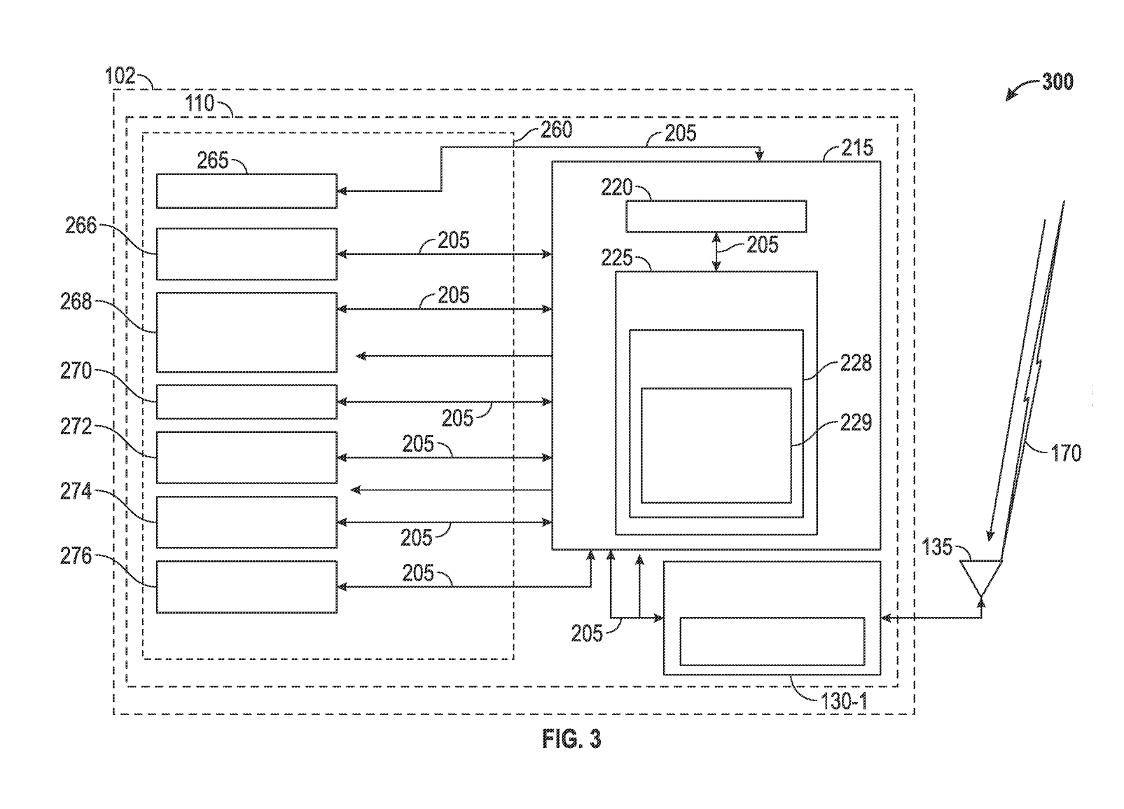

As illustrated in FIG. 1, in some embodiments, the vehicle 102 may include a network access device (NAD) 130-1 that is communicatively coupled to an automotive head unit (AHU) 160 that is part of an onboard computer system 110. In implementations where the vehicle 102 includes an integrated/embedded NAD, the NAD 130-1 and the AHU 160 can be communicatively coupled over any type of communication link including, but not limited to a wired communication link such as a USB connection, or a wireless communication link such as a Bluetooth communication link or WLAN communication link, etc. In other implementations, a portable consumer electronics device 130-2 can be present inside the vehicle 102 and can perform functions that would otherwise be performed by the embedded NAD 130-1. FIGS. 2 and 3 show specific embodiments of the NAD 130. In one embodiment, illustrated in FIG. 2, the NAD can be a consumer electronics device 230 (such as a portable wireless communication device or smartphone) that is located in (or alternatively in communication range of) the AHU 160 vehicle 102, and in another embodiment, illustrated in FIG. 3, the NAD 130 can be a communication device 130-1 that is embedded/integrated within the vehicle 102. As such, in the description that follows, a NAD 130 can refer generically to an embedded NAD 103-1 that is integrated within the vehicle 102, or a portable consumer electronics device 130-2 can be present inside the vehicle 102.

The communication system 100 may also include, in some implementations, communication infrastructure 180 that is communicatively coupled to the application servers 190, 195 via a NAD 130 through a network 185, such as, the Internet.

The onboard computer system 110 includes the AHU 160. The NAD 130-1 and AHU 160 can be communicatively coupled via a bus 105. An example implementation of the onboard computer system 110 will be described below with reference to FIGS. 2 and 3, and as will be described, the AHU 160 includes various infotainment system components that are not illustrated in FIG. 1 for sake of clarity. Further, it is noted that although the NAD 130-1 and AHU 160 are illustrated as separate blocks that are coupled via the bus 105, in other embodiments, the NAD 130-1 can be part of the AHU 160.

The NAD 130-1 is embedded and/or integrated into the vehicle 110. The NAD 130-1 can include at least one communication interface, and in many cases, a plurality of communication interfaces. The NAD 130-1 allows the vehicle 102 to communicate information over-the-air using one or more wireless communication links 170. The physical layer used to implement these wireless communication links can be implemented using any known or later-developed wireless communication or radio technology. In some embodiments, the wireless communication links can be implemented, for example, using one or more of Dedicated Short-Range Communications (DSRC) technologies, cellular radio technology, satellite-based technology, wireless local area networking (WLAN) or WI-FI® technologies such as those specified in the IEEE 802.x standards (e.g. IEEE 802.11 or IEEE 802.16), WIMAX®, BLUETOOTH®, near field communications (NFC), the like, or improvements thereof (WI-FI is a registered trademark of WI-FI Alliance, of Austin, Tex.; WIMAX is a registered trademark of WiMAX Forum, of San Diego, Calif.; BLUETOOTH is a registered trademark of Bluetooth SIG, Inc., of Bellevue, Wash.).

The communication infrastructure 180 allows the NAD 130 to communicate with the remote located application servers 190, 195 over wireless communication link(s) 170. Communication infrastructure 180 can generally be any public or private access point that provides an entry/exit point for the NAD 130 (within the vehicle 102) to communicate with an external communication network 185 over wireless communication link(s). Communications that utilize communication infrastructure 180 are sometimes referred to colloquially as vehicle-to-infrastructure, or V2I, communications. Depending on the implementation, the communication infrastructure 180 can be a cellular base station, a WLAN access point, a satellite, etc. that is in communication with servers 190, 195. The communication infrastructure 180 can include, for example, long-range communication nodes (e.g., cellular base stations 180 or communication satellites 180) and shorter-range communication nodes (e.g., WLAN access points 180) that are communicatively connected to the communication network 185. Communications between NAD 130 and shorter-range communication nodes are typically facilitated using IEEE 802.x or WiFi®, Bluetooth®, or related or similar standards. Shorter-range communication nodes can be located, for example, in homes, public accommodations (coffee shops, libraries, etc.), and as road-side infrastructure such as by being mounted adjacent a highway or on a building in a crowded urban area.

The communication network 185 can include a wide area network, such as one or more of a cellular telephone network, the Internet, Voice over Internet Protocol (VoIP) networks, local area networks (LANs), wide area networks (WANs), personal area networks (PANs), and other communication networks.

Communications from the NAD 130 to the remote servers 190, 195, and from the remote servers 190, 195 to the NAD 130, can traverse through the communication network 185. The NAD 130 allows the onboard computer system 110 including the AHU 160 of the vehicle 102 to communicate with the servers 190, 195 so that they can communicate with each other to share information, such as packetized data that can include audio information and/or video information, and corresponding textual information that corresponds to the audio information and/or video information. In addition, in some implementations, the NAD 130 can include communication interfaces that allow for short-range communications with other vehicles (not illustrated) (e.g., that allow the vehicle 102 to communicate directly with one or more other vehicles as part of an ad-hoc network without relying on intervening infrastructure, such as node 180). Such communications are sometimes referred to as vehicle-to-vehicle (V2V) communications. The DSRC standards, for instance, facilitate wireless communication channels specifically designed for automotive vehicles so that participating vehicles can wirelessly communicate directly on a peer-to-peer basis with any other participating vehicle.

The application servers 190, 195 are backend servers that include computer hardware for implementing virtual computers/machines at the application servers 190, 195. This virtual computer/machine can execute/run applications to provide information/content that can then be communicated over a network 185, such as the Internet, to communication infrastructure 180.

In general, the audio information that is generated at the application server 190 can be any type of audio information that has corresponding textual information associated therewith. For example, the audio information can be audio content of any form of entertainment information with associated synchronous text. Such entertainment information can also include video content that is associated with audio content (or vice versa, e.g., audio content that is associated with video content). For instance, in one embodiment, the first server 190 can be an Internet radio server that streams music (and in some implementations video information or images) to the device 130-2. This music includes lyrical content (e.g., a vocal sound part of a song or other musical work). In this case, the audio information is music that includes the lyrical content, and the corresponding textual information provided by application server 195 can comprise text of lyrics that match the lyrical content of the music (or vocal sound part of the musical work). This is only one non-limiting example of the types of information that can be generated at the application servers 190, 195 and then communicated to the communication infrastructure 180. Other examples will be described below.

Communication infrastructure 180 then communicates that information or content over a wireless communication link 170 to a NAD 130. In one embodiment, the wireless communication link 170 can be, for example, a third-generation (3G) or fourth generation (4G) communication link.

The NAD 130 provides wireless connectivity to the application servers 190, 195, and serves as a protocol adapter that interfaces with a synchronization module (not illustrated in FIG. 1) that runs/executes at a processor (not illustrated in FIG. 1) that is located in the vehicle 102. The network access device 130 receives the audio information and/or video information, and corresponding textual information that corresponds to the audio information and/or video information over the wireless communication link 170, and then communicates it (e.g., over another communication link 105 such as a wireless communication link or a bus within the vehicle) to a processor (not illustrated in FIG. 1) of the vehicle 102 that runs/executes the synchronization module (not illustrated in FIG. 1).

In accordance with the disclosed embodiments, the application servers 190, 195 generate information, and communicate it to the NAD 130 that is in the vehicle. For example, in some implementations, the first application server 190 can be associated with an Internet radio service (e.g., Pandora or TuneIn) that generates the information and/or video data, and streams this audio and/or video data over the network 185 to communication infrastructure 180. Communication infrastructure 180 can then communicate this audio and/or video information over a wireless communication link 170 to the NAD 130, and the NAD 130 can then provide this audio and/or video data to the AHU 160 so that it can be presented on a display (not illustrated) and played back over an audio system (not illustrated) of the vehicle.

The first application server 190 can communicate with the second application server 195 to indicate what audio information and/or video information has been requested from the NAD 130. The second application server 195 provides (e.g., generates) textual information corresponding to the audio information and/or video information and communicates the corresponding textual information over the network 185 to the communication infrastructure 180, which in turn communicates the corresponding textual information to the NAD 130 over the wireless communication link 170. The second application server 195 include or be communicatively coupled to a database that provides corresponding textual information as well as metadata associated with the corresponding textual information. In one embodiment, the second application server 195 includes a lyrical database (e.g., the Gracenotes lyrical database) that stores the corresponding textual information that is associated with or corresponds to particular information (e.g., music).

In one embodiment, the audio information and/or video information and the corresponding textual information can be provided from the NAD 130 to the AHU 160 in two separate streams. In another embodiment, the NAD 130 can communicate the information and the corresponding textual information to the AHU 160 in a single stream. The NAD 130 can communicate (or provide) the corresponding textual information and the information to the AHU 160 in the vehicle.

In one embodiment, a synchronization module that executes at a processor (not illustrated) of the AHU 160 can process the corresponding textual information and the audio and/or video information. Among other things, the synchronization module at the AHU 160 synchronizes the corresponding textual information with the audio and/or video information such that corresponding portions of the textual information and the audio and/or video information are synchronized with each other. The AHU 160 includes at least one audio system (not illustrated) and at least one display (not illustrated). The synchronization module provides the corresponding textual and/or video information to the display in synchronization with providing the audio information to the audio system. This way, as the audio information is being played back via the audio system, the corresponding textual information can be displayed at the display(s) in synchronization with the information that is being played back over the audio system.

In one implementation, after synchronization, the application at the AHU 160 can provide the synchronized corresponding textual information and/or video data to the display, and provide the synchronized information to the audio system. As portions of the audio information are played back via the audio system, corresponding portions of the corresponding textual information can be presented (e.g., rendered) on the display(s) of the AHU 160 in synchronization with the audio information and/or video content so that the textual information matches the audio being played back.

Specific Examples of Corresponding Textual Information

As used herein, the term “corresponding textual information” refers to a set of characters where each character is a unit of information that roughly corresponds to a grapheme in an alphabetic system of writing, a grapheme-like unit, or a symbol, such as in an alphabet or syllabary in the written form of a natural language. Examples of characters include letters, numerical digits, common punctuation marks (such as “.” or “-”), and whitespace. The textual information corresponds to audio information and/or video information.

Lyrical Content

In one embodiment, the textual information provided to the AHU 160 comprises lyrical data or content (such as lyrics that correspond to the information). In one implementation, this allows the AHU 160 to implement a karaoke system within the vehicle (i.e., lyrics that correspond to the words of a song are presented on a display while the song plays back over the audio system). For example, the lyrics of a song are displayed on a display, along with a moving symbol, changing color, or music video images, in synchronization with the audio information of the song to guide the passengers in following the lyrics of the song. The disclosed embodiments avoid the need to store a large lyrical database locally within the vehicle by providing a link to such a lyrical database at the second application server 195 that is external to the vehicle. This way an enhanced Internet radio application can be provided without increasing the cost or complexity of the AHU 160.

Sub-Title Content

In another embodiment, either the first server 190 or another server (not illustrated) can provide video information that corresponds to the information, and other types of textual information can be provided from server 195. For example, when video information (e.g., movies or television shows) are being streamed to the NAD 130 and occupants desire to view the video information along with subtitles, the server 195 can retrieve corresponding closed-captioning data or subtitles that correspond to speech or other dialog from an online subtitle database that is associated with the video information, and provide this information to the AHU 160. In one implementation, this allows the AHU 160 to implement a cost-effective closed-captioning system within the vehicle for video information that is being streamed to the vehicle from a video server.

In another embodiment, other types of textual information can also be communicated from an external server to the vehicle, such as text associated with an audio book, for example. In one implementation, this can allow the reading system to be implemented within the vehicle. This could be used by parents to help encourage their children (or other passengers) to read while on trips. In addition, audio and/or video language courses could also be streamed to the NAD 130, and corresponding textual information can be displayed using this methodology.

FIG. 2 is a diagram that illustrates a portion of a communication system 200 in accordance with one example of the disclosed embodiments. In the embodiment of FIG. 2, the network access device 130 of FIG. 1 is a consumer electronics device 130-2 such as a smartphone.

The vehicle 102 includes an onboard computer system 210. The onboard computer system 210 can vary depending on the implementation. In the particular example that is illustrated in FIG. 2, the onboard computer system 210 is illustrated as including a computer 215 and an automotive head unit (AHU) 260. Although the computer 215 and the AHU 260 are illustrated as being part of the onboard computer system 210, those skilled in the art will appreciate that the computer 215 and the AHU 260 can be distributed throughout the vehicle 102.

The consumer electronics device 130-2 is illustrated inside the vehicle 102 in FIG. 2, but it is not part of the vehicle 102 meaning that it is not integrated and/or embedded within the vehicle 102. Rather, consumer electronics device 130-2 can be carried into the vehicle 102 by an occupant and can then be communicatively coupled to the AHU 260 of the onboard computer system 210 via a wireless or wired connection.

The consumer electronics device 130-2 (also referred to below simply as a device 130-2) can be any type of electronics device that is capable of wireless communication with a network, and includes elements such as a transceiver, computer readable medium, processor, and a display that are not illustrated since those elements are known in the art. The device 130-2 can be, for example, any number of different portable wireless communications devices, such as personal or tablet computers, cellular telephones, smartphones, etc. In this regard, it is noted that as used herein, a smartphone refers to a mobile telephone built on a mobile operating system with more advanced computing capability and connectivity than a feature phone. In addition to digital voice service, a modern smartphone has the capability of running applications and connecting to the Internet, and can provide a user with access to a variety of additional applications and services such as text messaging, email, Web browsing, still and video cameras, MP3 player and video playback, etc. Many smartphones can typically include built in applications that can provide web browser functionality that can be used display standard web pages as well as mobile-optimized sites, email functionality, voice recognition, clocks/watches/timers, calculator functionality, personal digital assistant (PDA) functionality including calendar functionality and a contact database, portable media player functionality, low-end compact digital camera functionality, pocket video camera functionality, navigation functionality (cellular or GPS), etc. In addition to their built-in functions, smartphones are capable of running an ever growing list of free and paid applications that are too extensive to list comprehensively.

As will be described below, the consumer electronics device 130-2 can run installed applications locally and render content (including audio information, video information, and corresponding textual information) that can be communicatively coupled as data packets (e.g., as IP packets) to the onboard computer system 210 via a USB connection to ports 265 or via a Bluetooth or WLAN link to interfaces 266.

The computer 215 and the AHU 260 are coupled to each other via one or more in-vehicle buses 205 that are illustrated in FIG. 2 by one or more bus line(s) 205. As used herein, the bus 205 can include any internal vehicle bus. The bus 205 includes various wired paths that are used to interconnect the various systems and route information between and among the illustrated blocks of FIG. 2.

The onboard computer system 210 can include, or can be connected to, a computer 215 and an AHU 260 that embodies components of an infotainment system. It is noted that although certain blocks are indicated as being implemented with the onboard computer system 210, in other embodiments, any of these modules can be implemented outside the onboard computer system 210.

The computer 215 includes at least one computer processor 220 that is in communication with a tangible, non-transitory computer-readable storage medium 225 (e.g., computer memory) by way of a communication bus 205 or other such computing infrastructure. The processor 220 is illustrated in one block, but may include various different processors and/or integrated circuits that collectively implement any of the functionality described herein. The processor 220 includes a central processing unit (CPU) that is in communication with the computer-readable storage medium 225, and input/output (I/O) interfaces that are not necessarily illustrated in FIG. 2. In some implementations, these I/O interfaces can be implemented at I/O devices 268, displays 270, and audio systems 272 that are shown within the AHU 260. An I/O interface (not illustrated) may be any entry/exit device adapted to control and synchronize the flow of data into and out of the CPU from and to peripheral devices such as input/output devices 268, displays 270, and audio systems 272.

As will be explained in greater detail below, the processor 220 can receive information from each of the other blocks illustrated in FIG. 2, process this information, and generate communications signals that convey selected information to any of the other blocks including any human machine interface in the vehicle including the displays 270 and/or audio systems 272 of the AHU 260.

The computer-readable medium 225 can include any known form of computer usable or computer-readable medium. The computer-readable (storage) medium 225 can be any type of memory technology including any types of read-only memory or random access memory or any combination thereof. This encompasses a wide variety of memory technologies that include, for example but not limited to, an electronic, magnetic, optical, electromagnetic, infrared, or semiconductor system, apparatus, device, or propagation medium. Some non-limiting examples can include, for example, volatile, non-volatile, removable, and non-removable memory technologies. The term computer-readable medium and variants thereof, as used in the specification and claims, refer to any known non-transitory computer storage media. For example, storage media could include any of random-access memory (RAM), read-only memory (ROM), electrically erasable programmable read-only memory (EEPROM), solid state memory or other memory technology, CD ROM, DVD, other optical disk storage, magnetic tape, magnetic disk storage or other magnetic storage devices, and any other medium that can be used to store desired data. For sake of simplicity of illustration, the computer-readable medium 225 is illustrated as a single block within computer 215; however, the computer-readable storage medium 225 can be distributed throughout the vehicle including in any of the various blocks illustrated in FIG. 2, and can be implemented using any combination of fixed and/or removable storage devices depending on the implementation.

The AHU 260 is used to provide passengers in the vehicle with information and/or entertainment in various forms including, for example, music, news, reports, navigation, weather, and the like, received by way of radio systems, Internet radio, podcast, compact disc, digital video disc, other portable storage devices, video on demand, and the like.

In accordance with the disclosed embodiments, the AHU 260 is configured to receive audio information and/or video information from server 190, as well as corresponding textual information that corresponds to the audio information and/or video information from another server 195.

To provide passengers in the vehicle with this information, the AHU 260 includes various infotainment system components. In the example implementation illustrated in FIG. 2, the AHU 260 includes ports 265 (e.g., USB ports), one or more interface(s) 266 (e.g., Bluetooth and/or Wireless Local Area Network (WLAN) interface(s)), one or more input and output devices 268, one or more display(s) 270, one or more audio system(s) 272, one or more radio systems 274 and optionally a navigation system 276 that includes a global positioning system receiver (not illustrated). The input/output devices 268, display(s) 270, and audio system(s) 272 can collectively provide a human machine interface (HMI) inside the vehicle.

The input/output devices 268 can be any device(s) adapted to provide or capture user inputs to or from the onboard computer 110. For example, a button, a keyboard, a keypad, a mouse, a trackball, a speech recognition unit, any known touchscreen technologies, and/or any known voice recognition technologies, monitors or displays 270, warning lights, graphics/text displays, speakers, etc. could be utilized to input or output information in the vehicle 102. Thus, although shown in one block for sake of simplicity, the input/output devices 268 can be implemented as many different, separate output devices 268 and many different, separate input devices 268 in some implementations. As one example, the input/output devices 268 can be implemented via a display screen with an integrated touch screen, and/or a speech recognition unit, that is integrated into the system 260 via a microphone that is part of the audio systems 272.

Further, it is noted that the input/output devices 268 (that are not illustrated) can include any of a touch-sensitive or other visual display, a keypad, buttons, or the like, a speaker, microphone, or the like, operatively connected to the processor 220. The input can be provided in ways including by audio input. Thus, for instance, the onboard computer system 110 in some embodiments includes components allowing speech-to-data, such as speech-to-text, or data-to-speech, such as text-to-speech conversions. In another case, the user inputs selected information to the device 1302, which in turn communicates the information to the onboard computer system by wireless or wired communication.

The displays 270 can include any types and number of displays within the vehicle. For example, the displays 270 can include a visual display screen such as a navigation display screen or a heads-up-display projected on the windshield or other display system for providing information to the vehicle operator. One type of display may be a display made from organic light emitting diodes (OLEDs). Such a display can be sandwiched between the layers of glass (that make up the windshield) and does not require a projection system. The displays 270 can include multiple displays for a single occupant or for multiple occupants, e.g., directed toward multiple seating positions in the vehicle. Any type of information can be displayed on the displays 270 including information that is generated by the application servers 190, 195 of FIG. 1.

The radio systems 274 can include any known types of radio systems including AM, FM and satellite based radio systems.

The navigation systems 276 can include a global positioning system (GPS) device for establishing a global position of the vehicle. The GPS device includes a processor and one or more GPS receivers that receive GPS radio signals via an antenna (not illustrated). These GPS receivers receive differential correction signals from one or more base stations either directly or via a geocentric stationary or LEO satellite, an earth-based station or other means. This communication may include such information as the precise location of a vehicle, the latest received signals from the GPS satellites in view, other road condition information, emergency signals, hazard warnings, vehicle velocity and intended path, and any other information. The navigation systems 276 can also regularly receive information such as updates to the digital maps, weather information, road condition information, hazard information, congestion information, temporary signs and warnings, etc. from a server. The navigation systems 276 can include a map database subsystem (not illustrated) that includes fundamental map data or information such as road edges, the locations of stop signs, stoplights, lane markers etc. that can be regularly updated information with information from a server.

The navigation systems 276 can receive information from various sensors (not illustrated) as is known in the art. For example, in one implementation, the sensors can include an inertial navigation system (INS) (also referred to as an inertial reference unit (IRU)) that includes one or more accelerometers (e.g., piezoelectric-based accelerometers, MEMS-based accelerometers, etc.), and one or more gyroscopes (e.g., MEMS-based gyroscopes, fiber optic gyroscopes (FOG), accelerometer-based gyroscopes, etc.). For instance, three accelerometers can be implemented to provide the vehicle acceleration in the latitude, longitude and vertical directions and three gyroscopes can be employed to provide the angular rate about the pitch, yaw and roll axes. In general, a gyroscope would measure the angular rate or angular velocity, and angular acceleration may be obtained by differentiating the angular rate. The navigation systems 276 can be implemented using any component or combination of components capable of determining a direction of travel of the vehicle 102.

The ports 265 and interfaces 266 allow for external computing devices including the device 130-2 to connect to the onboard computer system 210 and the AHU 260. In some embodiments, the ports 265 can include ports that comply with a USB standard, and interfaces 266 can include interfaces that comply with a Bluetooth/WLAN standards. This way, the consumer electronics device 1302 can directly communicate (transmit and receive) information with the onboard computer system 210. This information can include audio information (and in some implementations video information) received from application servers (such as application server 190 of FIG. 1) via wireless communication link 170, as well as corresponding textual information that corresponds to the audio information and that is received from other application servers (such as application server 195 of FIG. 1) via wireless communication link 170.

The computer-readable storage medium 225 stores instructions 228 that, when executed by the processor, cause the processor 220 to perform various acts as described herein. The computer-readable storage medium 225 stores instructions 228 that can be loaded at the processor 220 and executed to generate information that can be communicated to the AHU 260. The instructions 228 may be embodied in the form of one or more programs or applications (not shown in detail) that may be stored in the medium 225 in one or more modules. While instructions 228 are shown generally as residing in the computer-readable storage medium 225, various data, including the instructions 228 are in some embodiments stored in a common portion of the storage medium, in various portions of the storage medium 225, and/or in other storage media.

In accordance with the disclosed embodiments, the instructions 228 include a synchronization module 229. In one embodiment, in response to a trigger event (e.g., detecting that a communication session has been started or established with the server 190 of FIG. 1), the synchronization module 229 can be loaded and executed at the processor 220 of the vehicle 102.

When the synchronization module 229 receives audio information and corresponding textual information (that corresponds to the audio information) from the device 130-2, the synchronization module 229 processes this information so that the audio information is synchronized with the corresponding textual information. In some implementations, the synchronization module 229 also receives video information from the device 130-2, and processes it so that the video information is also synchronized with the corresponding textual information and the audio information.

The synchronization module 229 communicates the audio information (and in some implementations the video information) and corresponding textual information to various components of AHU 260 so that is can be presented via a human machine interface (HMI) inside the vehicle 102 (e.g., displayed on displays and played back via audio systems). For instance, in one implementation, display(s) 270 and audio system(s) 272 located inside the cabin of the vehicle 102, such as a display and/or audio system that is part of an infotainment system, can receive the audio information that has been synchronized with the corresponding textual information from the synchronization module 229, and then play the audio information in synchronization with the corresponding textual information being displayed on the display(s) 270. This way, when audio information provided from the consumer electronics device 130-2 is played back via audio system(s) 272 of the vehicle 102, the corresponding textual information can be rendered on the display(s) 270 of the vehicle 102 so that passengers can read the corresponding textual information as the audio information is played back via audio system(s) 272.

FIG. 3 is a diagram that illustrates a portion of a communication system 300 in accordance with another example of the disclosed embodiments. In this exemplary, non-limiting example, the onboard computer system 110 of FIG. 3 differs from the implementation described above with reference to FIG. 2 in that the onboard computer system 110 includes an embedded NAD 130-1 and associated antenna(s) 135 that can be integrated within the vehicle 102. The implementation described with reference to FIG. 3 includes many of the same components described above with reference to FIG. 2. Those components are labeled with the same reference numerals, and any description of these commonly numbered components that is provided above with reference to FIG. 2 is equally applicable to FIG. 3. For sake of brevity the descriptions of those components will not be repeated in the description of FIG. 3.

The embedded NAD 1301 and associated antenna(s) 135 can receive information generated by the servers 190, 195 from the communication infrastructure 180. The computer 215 of the onboard computer system 110 is communicatively coupled to the embedded NAD 130-1 and the various components of the AHU 260 via one or more bus line(s) 205. The embedded NAD 130-1 and its associated antenna(s) 135 can perform similar functions to the consumer electronics device 130-2 of FIG. 2.

The embedded NAD 130-1 includes at least one antenna 135 that allows it to communicate with communication infrastructure 180 as described above. The embedded NAD 130-1 can be communicatively coupled to various components of an onboard computer system 110 via a wireless or wired connection including via bus 205. The bus 205 can include any internal vehicle bus and includes various wired paths that are used to interconnect the various systems and route information between and among the illustrated blocks of FIG. 3. For sake of brevity, the description of that communication will not be repeated here.

The embedded NAD 130-1 includes one or more wireless communication interfaces that facilitate communications to and from the system 110. While the embedded NAD 130-1 is illustrated in a single box, it will be appreciated that this box can represent multiple different wireless communication interfaces each of which can include multiple ICs for implementation of the receivers, transmitters, and/or transceivers that are used for receiving and sending signals of various types, including relatively short-range communications or longer-range communications, such as signals for a cellular communications network. The embedded NAD 130-1 is illustrated as being part of the onboard computer system 110, but can be implemented via one or more separate chipsets.

The embedded NAD 130-1 includes at least one receiver and at least one transmitter that are operatively coupled to at least one processor such as processor 220. The embedded NAD 130-1 can enable the vehicle to establish and maintain one or more wireless communications links (e.g., via cellular communications, WLAN, Bluetooth, and the like). The embedded NAD 130-1 can perform signal processing (e.g., digitizing, data encoding, modulation, etc.) as is known in the art. The embedded NAD 1301 can use communication techniques that are implemented using multiple access communication methods including frequency division multiple access (FDMA), time division multiple access (TDMA), code division multiple access (CDMA), orthogonal frequency division multiple access (OFDMA) in a manner to permit simultaneous communication with communication infrastructure 180 of FIG. 1.

The embedded NAD 130-1 can be used to exchange information over wide area networks 185, such as the Internet. This information can include audio information, and display information. The display information can include video information and/or corresponding textual information. The corresponding textual information can correspond to the audio information and/or video information. The display information can also include text information that corresponds to voice information (e.g., generated by a speech to text application), etc.

Depending on the implementation, the embedded NAD 130-1 can include any number of short range transceivers and long range transceivers depending on the particular implementation. The embedded NAD 130-1 can include wireless communication interfaces for relatively short-range communications that employ one or more short-range communication protocols, such as a dedicated short range communication (DSRC) system (e.g., that complies with IEEE 802.11p), a WiFi system (e.g., that complies with IEEE 802.11 a, b, g, IEEE 802.16, WI-FI®) BLUETOOTH®, infrared, IRDA, NFC, the like, or improvements thereof). In one embodiment, at least one communication interface of the embedded NAD 130-1 is configured as part of a short-range vehicle communication system, and allows the vehicle 102 to directly communicate (transmit and receive) information with other nearby vehicles (not illustrated). Likewise, the embedded NAD 130-1 can include wireless communication interfaces for longer-range communications such as cellular and satellite based communications that employ any known communications protocols. In one embodiment, one of the wireless communication interfaces of the embedded NAD 130-1 is configured to communicate over a cellular network, such as a third generation (3G) or fourth generation (4G) cellular communication network. Thus, the wireless communication interfaces that are included within the embedded NAD 130-1 can be implemented using any known wireless communications technologies including any of those described above.

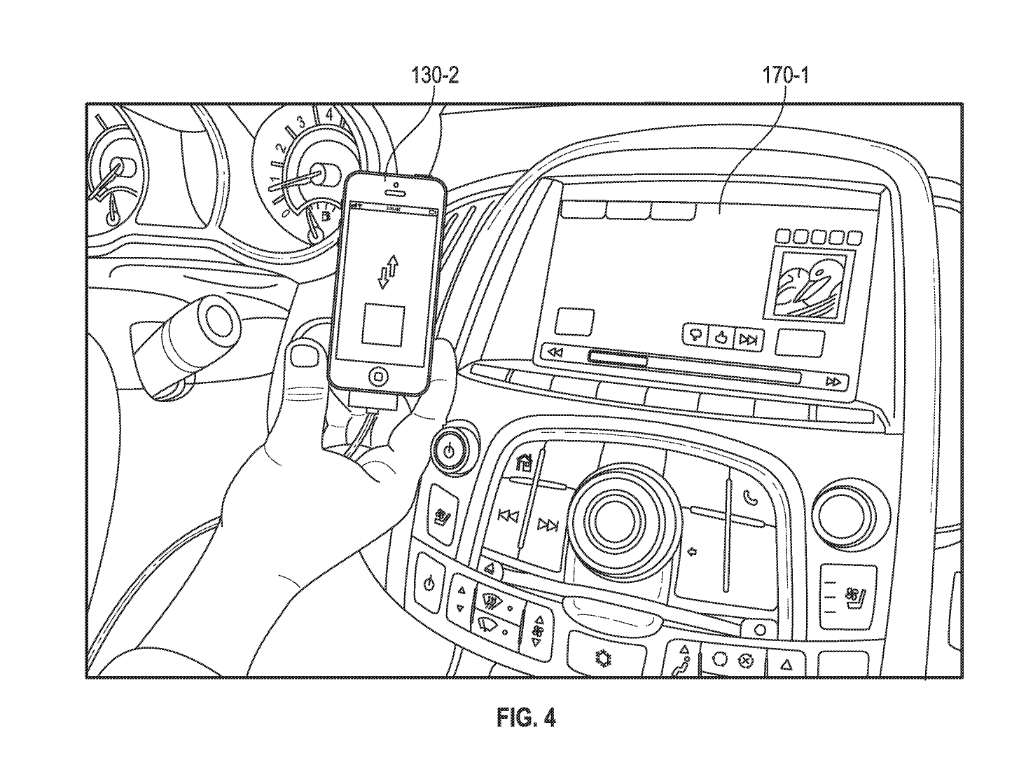

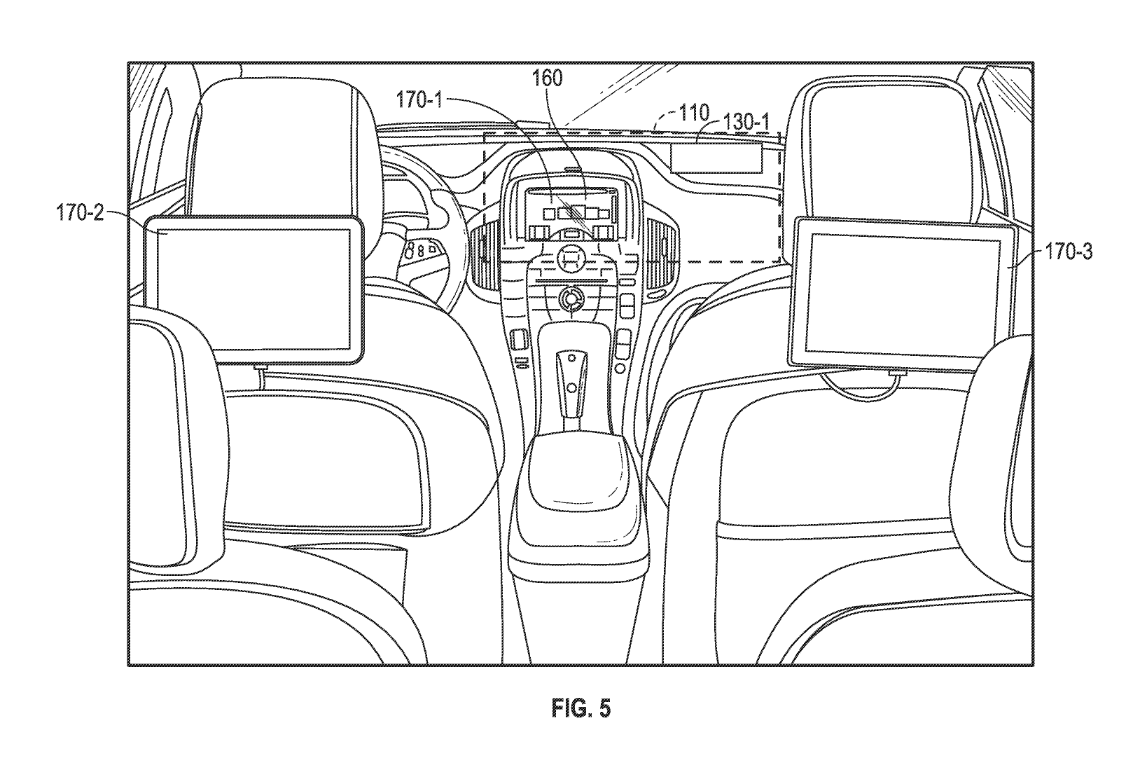

In some embodiments or implementations, it is desirable to prevent a driver of a vehicle from being distracted when driving by textual and/or video information. As such, it corresponding textual information (that corresponds to audio information being played) is only displayed on the displays that are located outside the view of the driver (e.g., within the rear of the vehicle or behind the driver) to prevent the driver from being distracted. To illustrate this concept, FIGS. 4 and 5 provide examples of an interior portion of a vehicle that includes displays that are described with reference to FIGS. 2 and 3.

FIG. 4 is a diagram that illustrates an example of an interior portion of a vehicle in accordance with one specific implementation. The interior portion of the vehicle includes a consumer electronics device 130-2 located therein, and in particular a smartphone, that is coupled via a USB connection to an AHU (not illustrated). One display 170-1 of the AHU is illustrated in FIG. 4. This display 170-1 is located in view of the driver and therefore would not be used to display corresponding textual information in order to prevent the driver from being distracted.

By contrast, FIG. 5 is a diagram that illustrates another example of an interior portion of a vehicle in accordance with one specific implementation. FIG. 5 shows that the interior portion of the vehicle includes three displays 170-1, 170-2, 170-3. The dotted-line rectangle 510 indicates one representation of a region of the vehicle 102 where an onboard computer system 110 could be integrated within the vehicle 102, and dotted-line rectangle 530-1 indicates one representation of a region of the vehicle 102 where an embedded NAD 130-1 could be integrated within the vehicle 102. The dotted-line rectangles are shown simply to demarcate possible region a within the vehicle 102 (of FIG. 1 or FIG. 3) where the onboard computer system 110 and the embedded NAD 130-1 could be integrated, but are by no means intended to be limiting.

The display 170-1 of the AHU is located in view of the driver and therefore would not be used to display corresponding textual information in order to prevent the driver from being distracted. However, the displays 170-2, 170-3 can be used to display corresponding textual information for passengers who are in the backseats of the vehicle so that they can read the corresponding textual information while the associated audio information is played back over an audio system of the vehicle (not shown). As noted above, in some implementations, the displays 170-2, 170-3 can be used to display corresponding textual information for passengers who are in the backseats of the vehicle so that they can read the corresponding textual information while associated video information is presented on the displays 170-2, 170-3. The displays 170-2 and 170-3 may include, but are not limited to, vehicle embedded displays as well as consumer electronic devices such as tablets, gaming systems, etc. Consumer electronic devices brought into the vehicle may function through any connection mechanism available, including Bluetooth, Wi-Fi, USB, and HDMI, etc.

The foregoing description has been presented for purposes of illustration and description, but is not intended to be exhaustive or limit the scope of the claims. The embodiments described above are described to best explain one practical application, and to enable others of ordinary skill in the art to understand the invention for various embodiments with various modifications as are suited to the particular use contemplated.

In some instances, well-known components, systems, or methods have not been described in detail in order to avoid obscuring the present disclosure. Therefore, specific operational and functional details disclosed herein are not to be interpreted as limiting, but merely as a representative basis for teaching one skilled in the art.

Those of skill in the art would further appreciate that the various illustrative logical blocks, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

While the description above includes a general context of computer-executable instructions, the present disclosure can also be implemented in combination with other program modules and/or as a combination of hardware and software. The terms “application,” “algorithm,” “program,” “instructions,” or variants thereof, are used expansively herein to include routines, program modules, programs, components, data structures, algorithms, and the like, as commonly used. These structures can be implemented on various system configurations, including single-processor or multiprocessor systems, microprocessor-based electronics, combinations thereof, and the like. Although various algorithms, instructions, etc. are separately identified herein, various such structures may be separated or combined in various combinations across the various computing platforms described herein.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

The block diagrams in the Figures illustrate the architecture, functionality, and operation of possible implementations of systems, methods and computer program products according to various embodiments of the present invention. In this regard, each block in the block diagrams may represent a module, segment, or portion of code, which comprises one or more executable instructions for implementing the specified logical function(s). It should also be noted that, in some alternative implementations, the functions noted in the block may occur out of the order noted in the figures. It will also be noted that each block of the block diagrams and/or flowchart illustration, and combinations of blocks in the block diagrams can be implemented by special purpose hardware-based systems that perform the specified functions or acts, or combinations of special purpose hardware and computer instructions.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

The detailed description provides those skilled in the art with a convenient road map for implementing the exemplary embodiment or exemplary embodiments. Many modifications and variations will be apparent to those of ordinary skill in the art without departing from the scope and spirit of the invention.

The above-described embodiments are merely exemplary illustrations of implementations set forth for a clear understanding of the principles of the disclosure. The exemplary embodiments are only examples, and are not intended to limit the scope, applicability, or configuration of the disclosure in any way. While exemplary embodiments have been presented in the foregoing detailed description, it should be appreciated that a vast number of variations exist. Variations, modifications, and combinations may be made to the above-described embodiments without departing from the scope of the claims. For example, various changes can be made in the function and arrangement of elements without departing from the scope of the disclosure as set forth in the appended claims and the legal equivalents thereof. All such variations, modifications, and combinations are included herein by the scope of this disclosure and the following claims.

What is claimed is:

1. A system, comprising:
a network access device (NAD) configured to receive audio information generated by a first server and corresponding textual information generated by a second server, wherein the corresponding textual information corresponds to the audio information; and
an automotive head unit (AHU) of a vehicle that is communicatively coupled to the NAD, the AHU comprising:
a processor configured to synchronize the audio information with the corresponding textual information; and
a human-machine interface (HMI) configured to present the corresponding textual information in synchronization with the audio information when the audio information is played on an audio system of the vehicle.

2. A system according to claim 1, wherein the AHU further comprises:
a first non-transitory computer-readable storage medium configured to store a synchronization module; and
wherein the processor comprises a first processor configured to load and execute the synchronization module, wherein the synchronization module is configured to synchronize the audio information with the corresponding textual information.

3. A system according to claim 1, wherein the AHU is configured to generate an indication that a display text mode has been selected at the AHU, and wherein the second server is configured to generate the corresponding textual information in response to the indication that the display text mode has been selected at the AHU.

4. A system according to claim 1, wherein the first server is an Internet radio server and wherein the audio information comprises a vocal sound part of a musical work and the corresponding textual information comprises lyrics that match the vocal sound part of the musical work.

5. A system according to claim 1, wherein the NAD is a consumer electronics device.

6. A system according to claim 5, wherein the consumer electronics device is a smartphone.

7. A system according to claim 1, wherein the NAD is embedded into and integrated within the vehicle.

8. A system according to claim 1, wherein the audio information comprises:
any information that has corresponding textual information associated therewith.

9. A system according to claim 1, wherein the audio information comprises entertainment information comprising at least one of:
audio content with associated synchronous text,
audio content that is associated with video content, and
wherein the audio content comprises at least one of: speech or dialog.

10. A computer-implemented method for providing information and corresponding textual information to an automotive head unit (AHU) of a vehicle, the computer-implemented method comprising:
generating audio information at a first server, and communicating the audio information from the first server to a wireless communication interface of a network access device (NAD) that is located at a vehicle;
generating, at a second server, corresponding textual information that is associated with the audio information, and communicating the corresponding textual information from the second server to the wireless communication interface of the NAD;
communicating the audio information and the corresponding textual information from the NAD to an automotive head unit (AHU) of the vehicle;
processing the audio information and the corresponding textual information at the AHU, wherein processing comprises: synchronizing the audio information with the corresponding textual information; and
presenting the corresponding textual information at a human-machine interface (HMI) of the AHU in synchronization with the audio information.

11. A computer-implemented method according to claim 10, further comprising:
loading, at a first processor of the AHU, a synchronization module from a first non-transitory computer-readable storage medium;
selecting a display text mode at the AHU, and communicating an indication that the display text mode has been selected at the AHU to the first server and to the second server;
wherein the step of generating the audio information at the first server, comprises:
executing, at the first server in response to the indication that the display text mode has been selected at the AHU, the first application to generate the audio information that is to be provided to the AHU of the vehicle;
wherein the step of generating, at the second server, the corresponding textual information that is associated with the audio information, comprises:
executing, at the second server in response to the indication that the display text mode has been selected at the AHU, the second application to generate the corresponding textual information that is associated with the audio information; and
further comprising:
executing the synchronization module, at the first processor, wherein the step of executing, comprises the step of synchronizing the audio information with the corresponding textual information.

12. A computer-implemented method according to claim 10, wherein the audio information comprises entertainment information comprising at least one of:
audio content with associated synchronous text,
audio content that is associated with video content, and
wherein the audio content comprises at least one of: speech or dialog.

13. A computer-implemented method according to claim 10, wherein the first server is an Internet radio server, wherein the audio information is a vocal sound part of a musical work and the corresponding textual information comprises lyrics that match the vocal sound part of the musical work.

14. A computer-implemented method according to claim 10, wherein the NAD is a consumer electronics device that is configured to host and execute an Internet radio application to process the audio information and provide the audio information to the human-machine interface of the AHU.

15. A computer-implemented method according to claim 14, wherein the consumer electronics device is a smartphone.

16. A vehicle, comprising:
a wireless communication interface configured to receive audio information and corresponding textual information via a wireless communication link; and
an automotive head unit (AHU), communicatively coupled to the wireless communication interface, the AHU comprising:
a processor configured to synchronize the audio information with the corresponding textual information; and
a human-machine interface (HMI) configured to present the corresponding textual information in synchronization with the audio information.

17. A vehicle according to claim 16, wherein the AHU further comprises:
a non-transitory computer-readable storage medium configured to store a synchronization module; and
a processor configured to load and execute the synchronization module, wherein the synchronization module is configured to synchronize the audio information with the corresponding textual information.

18. A vehicle according to claim 16, wherein the AHU is configured to generate an indication that a display text mode has been selected at the AHU, and wherein the corresponding textual information is generated in response to the indication that the display text mode has been selected at the AHU.

19. A vehicle according to claim 16, wherein the audio information comprises a vocal sound part of a musical work and the corresponding textual information comprises lyrics that match the vocal sound part of the musical work.

20. A vehicle according to claim 16, wherein the audio information comprises:
any information that has corresponding textual information associated therewith.
